(19) United States
(12) Patent Application Publication
(10) Pub. No.: US 2004/0049467 A1
(43) Pub. Date: Mar. 11, 2004

(54) Single account world wide web/internet authentication/purchase system and method

(76) Inventor: Jeffrey D. Blair, El Dorado Hills, CA (US)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/241,031

(22) Filed: Sep. 11, 2002

(51) Int. Cl. G06F 17/60

(52) U.S. Cl. 705/75

(57) ABSTRACT

An apparatus (30) and method for electronic authentication of electronic transactions conducted on the WWW/Internet. Users (11) can create and manage an individual account specifically for the purpose of proving ones identity and authority to access or engage in a wide variety of electronic activities such as purchasing, accessing confidential information, authorizing transactions, etc. User devices (14,15,16,17,18) are connected to a security application service provider system (31) and security system (32) that maintain the individual accounts and communicate with participating vendors (33). The service provider system (31) generates standard command buttons (40,43,44) and text boxes (41,42) for the users (11).

### BACKGROUND OF THE INVENTION

The present invention relates to a system and a method for providing a user with a universally accepted identification and authentication account for engaging in electronic transactions over the World Wide Web (WWW) and Internet.

The current method of “authentication” on the WWW/Internet involves a user who initiates an account on the provider's system/database. For each account the user must provide confidential information such as credit card information, age, address, etc. Once this is completed, the user then chooses a user name (user-ID) and password (pass code) to “authorize” merchant/institution use or access to the account. If the user wants to initiate a transaction with a second merchant/institution, the user must repeat the process with the new merchant/institution. Before long, the user has several accounts with several different merchants/institutions that have access to the user's confidential information. This represents a security risk problem and the user must remember the user name and password or each account which can be inconvenient for the user.

### SUMMARY OF THE INVENTION

The system and method according to the present invention solve the problems and inconveniences of the prior art method of authentication by eliminating individual accounts in favor of a central, universally accepted account. By way of example, and not of limitation, the system and method according to the present invention concern an electronic authentication system designed specifically for the WWW/Internet whereby users can create and manage an individual personal use or business use account specifically for the purpose of proving one's identity and authority to access or engage in a wide variety of electronic (WWW/Internet) activities such as purchasing, accessing confidential information, authorizing transactions, etc. It is intended that the system and method according to the present invention become universally accepted as a standard amongst a variety of merchants, government agencies, banking agencies, educational institutions, business-to-business transactions, etc., as a method to securely validate an electronic WWW/Internet transaction while maintaining the confidentiality of user information. It is also the intent that the system and method according to the present invention replace the several individual “user-ID's” and “passwords” a person may have with individual merchants/institutions, with one central account.

Accordingly, the system and method according to the present invention are identified herein as the “Inter-Net-ID” which provides the following benefits:

A. User

1. One user account to engage in a variety of “authentication necessary” transactions.

2. Increased security: only one entity knows confidential information.

3. Centralized administration: User can easily get reports on activity.

4. Centralized security: User need only be concerned with the security credentials of the “Inter-Net-ID” service provider.

5. If desired, and made a condition of the transaction, the “Inter-Net-ID” service provider can act as an “escrow” agent to provide mutual satisfaction for both merchant and user in the transaction.

B. Merchant/Administrations/Institutions

1. Reduced administration costs: Databases need only be managed/maintained for transaction information; i.e. invoices, receipts, etc. Electronic funds transfer handled, and associated security risks are the responsibility of the “Inter-Net-ID” service provider.

2. Increased sales/transactions: Ease of use and convenience realized by the user will cause them to “seek out”” merchants and institutions that accept the “Inter-Net-ID” standard.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a block diagram of the prior art system for electronic transactions between customers and vendors; and

FIG. 2 is a block diagram of a system for electronic transactions in accordance with the present invention.

### DESCRIPTION OF THE PREFERRED EMBODIMENT

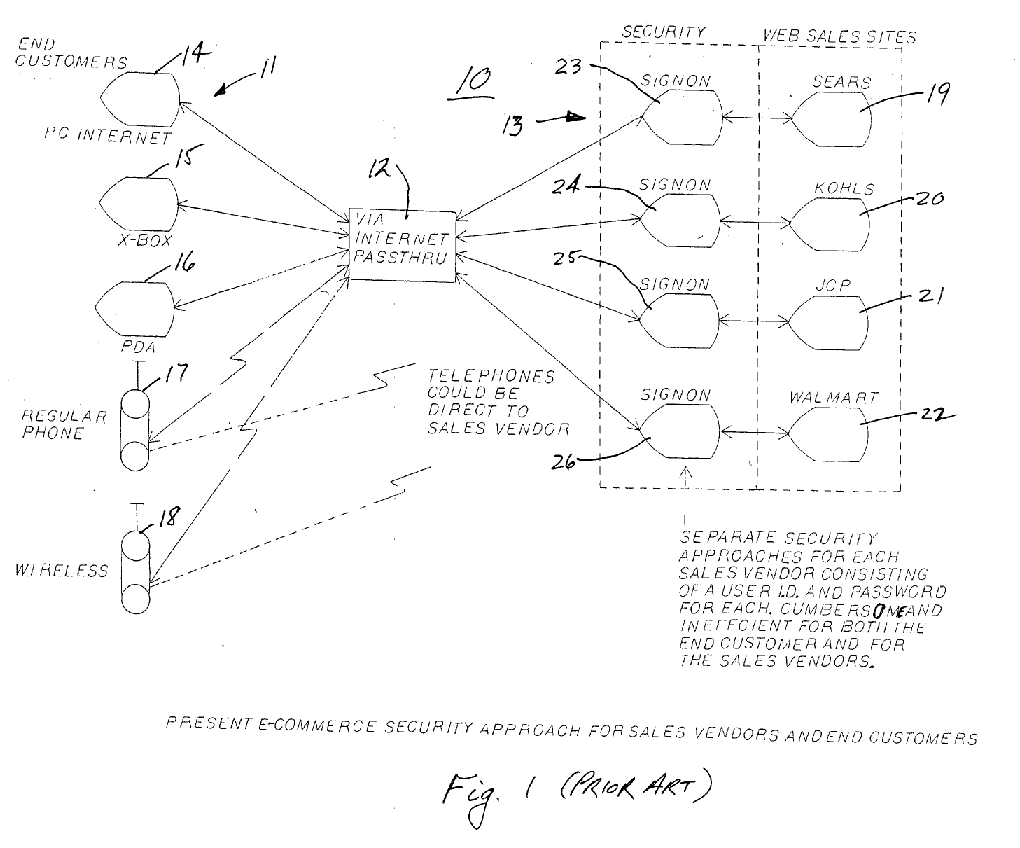

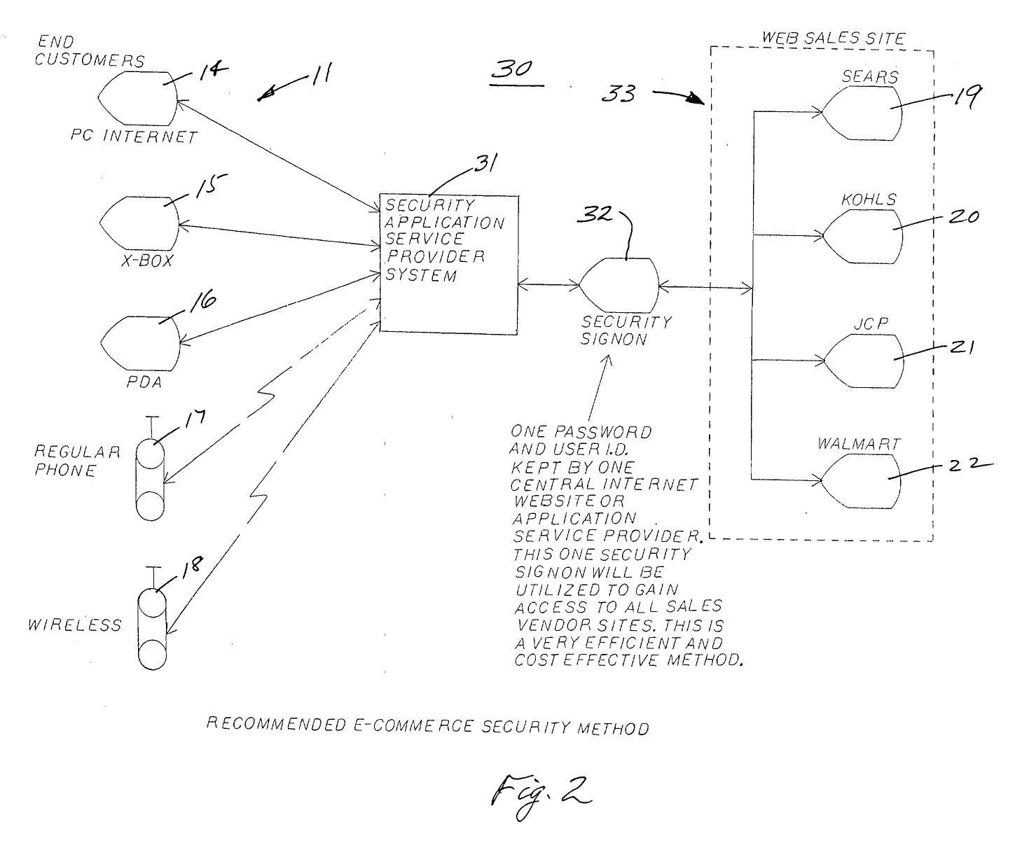

There is shown in FIG. 1 the present approach to secured transactions on the Internet. An electronic system 10 links a plurality of customers or users 11 via the Internet 12 to a plurality of vendors 13. The customers 11 can use any of a number of interface devices such as a personal computer (PC) 14, an X-box cable unit 15, a personal digital assistant (PDA) 16, a regular telephone 17 or a wireless telephone 18. Each of the devices 14 through 18 has a connection to the Internet 12 typically through an Internet Service Provider (ISP). Each of the customers 11 desires to conclude electronic transactions with two or more of the vendors 13 each having a web based sales site. For example, well known retailers maintain web sites such as a Sears, Roebuck & Co. web site 19 at “sears.com”, a Kohls Department Store web site 20 at “kohls.com”, a JCPenny (JCP) web site 21 at “jcpenny.com” and a Wal-Mart web site 22 at “walmart.com” are shown. Each of the web sales sites 19 through 22 has associated therewith a separate security system to protect both the customer and the vendor. Thus, the web sales sites 19 through 22 are connected to the Internet 12 by security systems 23 through 26 respectively.

At present, the end customer/consumer 11, using the Internet 12, connects to a security system of one of the vendors for a “shopping trip”. This site need not be a sales site as it could be any web site where the end customer/consumer 11 is requesting entrance into for acquiring a product, a service and/or information. The point is that the end customer/consumer 11 is out to “acquire something” from the web site in question whether or not payment is required in exchange. The use of the term “sales site” in FIG. 1 is an all encompassing term used to define a web site that will “supply something” to the end customer/consumer 11. In regards to this, sometime during the period that the end customer/consumer is “at” the site, especially if an actual purchase of “something” is carried out from the web site in question, the end customer/consumer will be required to supply to the web site in question a security identification. This security identification will be in the form of a “user I.D.” and a “password” that will identify the specific end customer/consumer to the web site in question.

Each of the web sites 19 through 22 carries with it its own security identification for these purposes. The end customer/consumer must keep track of each and every security I.D. and associated password that he/she has accessed and wish to continue to access. Each web site must keep and store this security I.D. and password for identification purposes later and each web site must construct and maintain its own security software system 23 through 26 for identification and verification purposes. This software is designed in FIG. 1 as the “SIGNON” security systems 23 through 26 required for access to the web sales sites 19 through 22 respectively. This is an extremely inefficient process and not cost effective at all, especially for the web sales sites in question. Duplication of cost expenditure and effort by each and every web sales site to carry out this security process is extremely large. On the end customer/consumer side, the confusion that results from having to keep and maintain separate security I.D.'s and passwords for each and every web sales site is quite large. This confusion also adds much complexity to what should be an easy and straightforward electronic transaction process to carry out from the end customer/consumer's perspective.

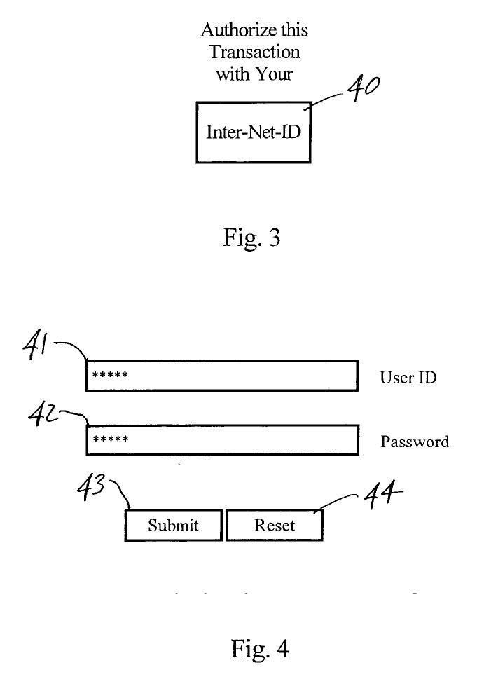

There is shown in FIG. 2, a single account electronic transaction system 30 that provides a solution to the Internet security issue as posed and outlined above with reference to FIG. 1. This solution is to have a “central repository” or controlling software system located on the Internet where all security identifications for all users can be added, maintained, verified, and updated. In the FIG. 2, there is shown a Security Application Service Provider (ASP) system 31 and associated security system 32 connected between the customers 11 and a plurality of vendors 33 such as the vendor web sites 19 through 22. The systems 31 and 32 could be any known concept or approach that allows for the security I.D.'s to be added, maintained, verified and updated in one location only. With this approach, the end customer/consumer 11 enters the ASP location once through his/her device 14 through 18 and identifies himself/herself by use of the associated security I.D. Once identified, the customers 11 then “pass through” to any and all of the web sales sites 19 through 22 to pursue their attainment of products, services and/or information as they require. The security I.D. is passed to the particular web site in question by the common security system 32 when the site calls for it or on first entry into the site by the end customer/consumer 11. This security I.D. is supplied to each and every Internet web site that the end customer/consumer 11 enters and utilizes for his/her own purposes.

This approach and method is efficient and extremely cost effective. It is efficient for the end customer/consumer in that he/she has only one sign on (i.e. user I.D. and password) to remember and maintain instead of the myriad of user I.D.'s and passwords under the “old” concept of security. This approach is extremely efficient and very cost effective for the Internet web sales sites in that they no longer each have to construct and maintain extremely complex security software programs and systems to be utilized to examine and verify the security of each and every person that accesses their Internet web sales site. This is an extremely large cost saving to each and every Internet web sales site and vendor. In addition, efficiencies of scale can be achieved as the end customer/consumer 11 can be passed directly into the Internet web sales site after his/her security has been passed from the central security repository 31, 32 to the particular Internet web sales site of the vendor 33 in question. This allows the Internet web sales site computer hardware equipment and software programs to be strictly devoted to the act of servicing the end customer/consumer's needs and requirements, and not in trying to satisfy heavy security verification and operating procedures as implemented by the Internet web sales site.

The system and method according to the present invention are referred to as the “Inter-Net-ID” and comprise the following:

1. Both users 11 and merchants/administrations/institutions must first set up an account with the Inter-Net-ID provider. During this process, the account holder provides the necessary authentication information as well as banking and identity information. The information provided is kept confidential and can vary depending on the type of account (i.e. user, merchant, institution, etc.).

2. Merchant/administration/institution accounts are then provided with account specific “software code” that they integrate into their web site. The result of the code is a push button that appears on the account web page. Each push button looks the same and is consistent on all “Inter-Net-ID” enabled account web pages. However, when the user “pushes” the button, the software executed is specific to the merchant/administration/institution account. For example, there is shown in FIG. 3 a command button 40 labeled “Authorize this Transaction with Your Inter-Net-ID”.

3. When the push button 40 is pushed, the user is transferred to the Inter-Net-ID “log-in” web page where he/she is asked to provide authentication information. For example, there is shown in FIG. 4 a text box 41 labeled “User ID” and a text box 42 labeled “Password” for entering such information. Once entered, the information can be submitted via a command button 43 labeled “Submit” or erased via a command button 44 labeled “Reset”.

4. The software code that executes when the push button is pushed also transfers transaction data to the Inter-Net-ID provider's database. This process takes place using state-of-the-art data encryption and security so the data is protected. When the user provides the proper credentials (User ID and Password, again encrypted), the transaction is completed, funds (if a financial transaction) are transferred between vendor and user accounts. Financial account numbers, etc. were previously provided when the account(s) were set up, so the transaction happens instantaneously. Note that neither party is aware of the other party's confidential information.

5. Upon completion, the user is transferred back to the merchant/administration/institution web site/page. At the same time the user's ship-to address, name etc. are recorded in the vendor's database for transaction processing. If the transaction was non-financial (i.e. purely “authentication”) he/she is returned to “privates areas of the merchant/administration/institution web site.

6. An added feature of this system is the possibility that the “Inter-Net-ID” provider can act as an escrow agent in the transaction. In this case, funds are not transferred until the user approves (or delivery is verified) the transaction. The vendor can specify this “customization” when the account is initially setup.

7. Merchandise returns: If funds have been transferred and the purchaser (user) has been approved to return merchandise, the process is reversed. In this case it is “like” an escrow transaction in that the merchant must “approve” the refund when the merchandise is received. The “Inter-Net-ID” service provider then transfers the reverse transaction funds. Again, a custom push button (i.e. software code) can be supplied to the merchant for this purpose.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. An electronic authentication system for enabling electronic transactions comprising:
a security application service provider system adapted to communicate with devices associated with a plurality of predetermined customers and storing information related to one individual account for each of the customers; and
a security system connected to said security application service provider system and adapted for communication with a plurality of predetermined vendors,
whereby when one of the devices communicates with said security application service provider system, the one of the customers associated with the one device can direct said security system to connect the one device to any one of said predetermined vendors selected by the one customer for enabling an electronic transaction between the one customer and the selected vendor.

2. The system according to claim 1 wherein each said individual account includes User ID and Password information.

3. The system according to claim 2 wherein said security application service provider system generates at least one text box on a display associated with the one device whereby the one customer can enter said User ID and Password information.

4. The system according to claim 3 wherein said security application service provider system generates a Submit command button on the display whereby the one customer can push said command button to transmit said User ID and Password information to said security application service provider system.

5. The system according to claim 3 wherein said security application service provider system generates a Reset command button on the display whereby the one customer can push said command button to erase said User ID and Password information from said at least one text box.

6. The system according to claim 1 wherein said security application service provider system generates an Inter-Net-ID command button on a display associated with the one device whereby the one customer can push said command button to authorize the electronic transaction.

7. The system according to claim 1 wherein said security application service provider system is adapted to communicate with the devices utilizing the World Wide Web.

8. The system according to claim 1 wherein said security system is adapted to communicate with the vendors utilizing the World Wide Web.

9. A method of electronic authentication for enabling electronic transactions comprising the steps of:
a. providing a security application service provider system adapted for communication with devices associated with a plurality of predetermined customers;
b. storing information in the security application service provider system related to one individual account for each of the customers;
c. providing a security system connected to the security application service provider system and adapted for communication with a plurality of predetermined vendors;
d. connecting one of the devices to the security application service provider system; and
e. utilizing the one device to direct the security system to connect the one device to any one of said predetermined vendors selected by the one customer associated with the one device for enabling an electronic transaction between the one customer and the selected vendor.

10. The method according to claim 9 wherein said step b. is performed by storing unique User ID and Password information for each of the individual accounts.

11. The method according to claim 10 wherein said step b. is performed by generating at least one text box on a display associated with the one device whereby the one customer can enter the User ID and Password information.

12. The method according to claim 11 wherein said step b. is performed by generating a Submit command button on the display whereby the one customer can push the command button to transmit the User ID and Password information to the security application service provider system.

13. The method according to claim 11 wherein said step b. is performed by enerating a Reset command button on the display whereby the one customer can push he command button to erase said User ID and Password information from the at least ne text box.

14. The method according to claim 9 including a step of generating an Inter-Net-ID command button on a display associated with the one device whereby the one customer can push the command button to authorize the electronic transaction.

15. The method according to claim 9 wherein said step d. is performed by connecting the security application service provider system to the one device utilizing the World Wide Web.

16. The method according to claim 9 wherein said step e. is performed by connecting the security system to the selected vendor utilizing the World Wide Web.
